(19) United States
(12) Patent Application Publication
(10) Pub. No.: US 2012/0212544 A1
(43) Pub. Date: Aug. 23, 2012

(54) MOUNTING MEMBER WITH DUAL-FED INK PASSAGEWAYS

(76) Inventor: Brian Gray Price, Pittsford, NY (US)

(21) Appl. No.: 13/032,918

(22) Filed: Feb. 23, 2011

(51) Int. Cl. B41J 2/145

(52) U.S. Cl. 347/40

(57) ABSTRACT

An inkjet printhead includes a printhead die including an array of nozzles disposed along a nozzle array direction and an ink feed opening that is fluidically connected to the array of nozzles; and a mounting member including: a first surface to which the printhead die is affixed; a second surface opposite the first surface; and an ink passageway from the second surface to the first surface, the ink passageway including: an elongated opening disposed on the first surface, the elongated opening being adjacent the ink feed opening of the printhead die; and a first opening and a second opening disposed on the second surface, the first and second openings being fluidically connected to the elongated opening disposed on the first surface.

### FIELD OF THE INVENTION

This invention relates generally to the field of inkjet printing, and more particularly to a mounting member for an inkjet printhead die.

### BACKGROUND OF THE INVENTION

Many types of inkjet printing systems include one or more printheads that have arrays of nozzles that are controlled to make marks of particular sizes, colors and densities in particular locations on the print media in order to print the desired image. In some types of printing systems, the array of nozzles extends across the width of the page, and the image can be printed one line at a time. However, the cost of a printhead that includes a page-width array of nozzles can be too high for some types of printing applications, so a carriage printing architecture is often used.

In a carriage printing system such as a desktop printer, or a large area plotter, the printhead or printheads are mounted on a carriage that is moved past the recording medium in a carriage scan direction as the drop ejectors corresponding to the nozzles are actuated to make a swath of dots. At the end of the swath, the carriage is stopped, printing is temporarily halted and the recording medium is advanced. Then another swath is printed, so that the image is formed swath by swath. In a carriage printer, the nozzle arrays are typically disposed along an array direction that is substantially parallel to the media advance direction, and substantially perpendicular to the carriage scan direction. The length of the nozzle array determines the maximum swath height that can be used to print an image.

An inkjet printhead can include one or more inkjet printhead die mounted on a mounting member. In an inkjet printhead die, the drop ejectors include a nozzle and a drop forming mechanism, such as a bubble-nucleating heater or a piezoelectric actuator. The drop ejectors of a given nozzle array are fluidically connected to a corresponding ink feed in the printhead die that is fluidically connected to a corresponding ink passageway in the mounting member. For printheads having a plurality of ink sources (such as cyan, magenta, yellow and black), an ink manifold is typically used to provide fluidic channels between the relatively widely spaced ink tanks and the relatively narrowly spaced ink passageways in the mounting member.

Inkjet ink includes a variety of volatile and nonvolatile components including pigments or dyes, humectants, image durability enhancers, and carriers or solvents. A key consideration in ink delivery is the ability to produce high quality images on the print medium. Image quality can be degraded if air bubbles block the small ink passageways from the ink supply to the array of drop ejectors. Such air bubbles can cause ejected drops to be misdirected from their intended flight paths, or to have a smaller drop volume than intended, or to fail to eject. Air bubbles can arise from a variety of sources. Air that enters the ink supply through a non-airtight enclosure can be dissolved in the ink, and subsequently be exsolved (i.e. come out of solution) from the ink in the printhead at an elevated operating temperature, for example. Air can also be ingested through the printhead nozzles. For a printhead having replaceable ink supplies, such as ink tanks, air can also enter the printhead when an ink tank is changed.

U.S. Patent Application Publication No. 2008/0149024, incorporated herein by reference, discloses a mounting member that is insert molded into a substrate. The mounting member includes fluid channels, each of which provides fluid to a corresponding array of drop ejectors. One fluid port is provided per fluid channel. A similar arrangement of one fluid port per fluid channel is disclosed in U.S. Patent Application Publication No. 2010/0156989, incorporated herein by reference, where the mounting member is made by a two shot injection molding process.

In some instances it has been found that air bubbles can become stuck at the fluid port in mounting member configurations such as those described in '024 and '989. Such bubbles can impede the flow of ink and can result in degraded print quality. What is needed is a mounting member configuration that facilitates removal of air bubbles at such locations in the printhead.

### SUMMARY OF THE INVENTION

The present invention is directed to overcoming one or more of the problems set forth above. Briefly summarized, according to one aspect of the invention, the invention resides in an inkjet printhead that includes: a printhead die including an array of nozzles disposed along a nozzle array direction and an ink feed opening that is fluidically connected to the array of nozzles; and a mounting member including: a first surface to which the printhead die is affixed; a second surface opposite the first surface; and an ink passageway from the second surface to the first surface, the ink passageway including: an elongated opening disposed on the first surface, the elongated opening being adjacent the ink feed opening of the printhead die; and a first opening and a second opening disposed on the second surface, the first and second openings being fluidically connected to the elongated opening disposed on the first surface.

### BRIEF DESCRIPTION OF THE DRAWINGS

FIG. 1 is a schematic representation of an inkjet printer system that can be used in accordance with the present invention;

FIG. 2 is a perspective of a portion of a printhead that can be used in the inkjet printer system of FIG. 1;

FIG. 3 is a top perspective of a portion of a carriage printer;

FIG. 4 is a schematic side view of an exemplary paper path in a carriage printer;

FIG. 5 is a perspective view of a multi-chamber ink supply;

FIG. 6 is a perspective of a portion of a printhead, rotated from the view of FIG. 2.

FIG. 7 is a bottom view of a prior art manifold for providing ink passages from ink supply ports to feed passages near ink openings in the printhead die;

FIG. 8 is an exploded view of two printhead die (nozzles facing up) and a prior art mounting member including ink passageways;

FIG. 9 is an exploded view of the printhead die and prior art mounting member of FIG. 8 rotated so that nozzles are facing down;

FIG. 10 is a cross-sectional view of one of the ink passageways of the prior art mounting member of FIGS. 8 and 9;

FIG. 11 is a cross-sectional view similar to FIG. 10, but also including a printhead die, a prior art manifold, and a bubble that is stuck at an opening of the ink passageway;

FIG. 12 is an exploded view (similar orientation as FIG. 9) of printhead die and a mounting member according to an embodiment of the invention;

FIG. 13 is a cross-sectional view of one of the ink passageways of the mounting member of FIG. 12;

FIG. 14 is a cross-sectional view similar to FIG. 13, but also including a printhead die, a prior art manifold, and a bubble that can flow past an opening of the ink passageway;

FIG. 15 is a bottom view of a manifold according to an embodiment of the invention, with passageways omitted for clarity; and

FIG. 16 is a bottom view of the manifold of FIG. 15 together with a single piece gasket around the manifold ink supply openings.

### DETAILED DESCRIPTION OF THE INVENTION

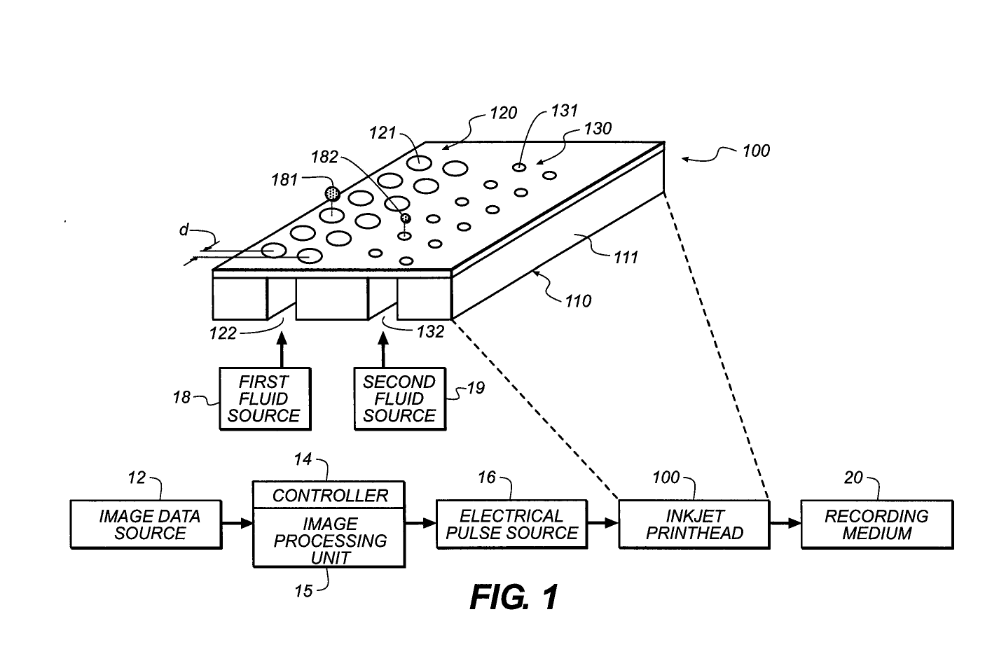

Referring to FIG. 1, a schematic representation of an inkjet printer system is shown that is useful with the present invention. This inkjet printer system is fully described in U.S. Pat. No. 7,350,902, which is incorporated by reference herein in its entirety. The inkjet printer system includes an image data source 12, which provides data signals that are interpreted by a controller 14 as being commands to eject drops. Controller 14 includes an image processing unit 15 for rendering images for printing, and outputs signals to an electrical pulse source 16 of electrical energy pulses that are inputted to an inkjet printhead 100, which includes at least one inkjet printhead die 110. Optionally, image processing unit 15 is partially included directly in the inkjet printer system, and partially included in a host computer.

In the example shown in FIG. 1, there are two nozzle arrays. Nozzles 121 in the first nozzle array 120 have a larger opening area than nozzles 131 in the second nozzle array 130. In this example, each of the two nozzle arrays has two staggered rows of nozzles, each row having a nozzle density of 600 per inch. The effective nozzle density then in each array is 1200 per inch (i.e. d= 1/1200 inch in FIG. 1). If pixels on a recording medium 20 were sequentially numbered along the paper advance direction, the nozzles from one row of an array would print the odd numbered pixels, while the nozzles from the other row of the array would print the even numbered pixels.

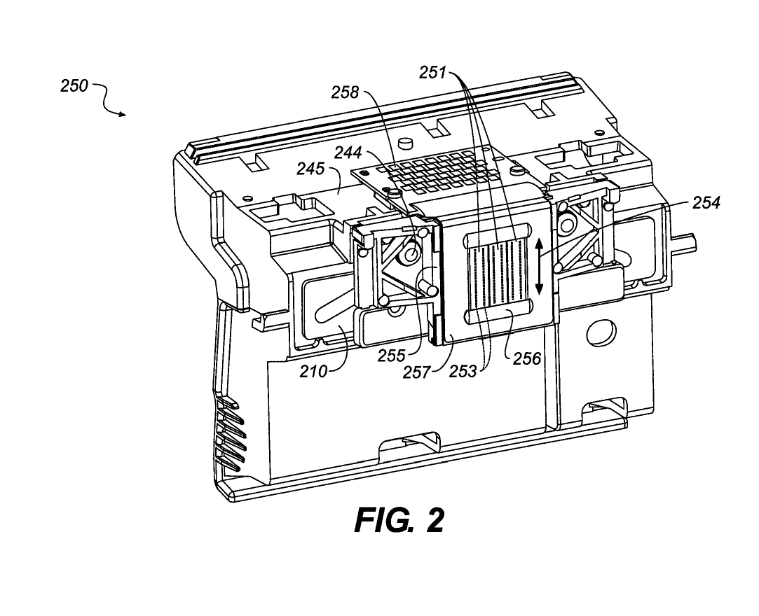

In fluid communication with each nozzle array is a corresponding ink delivery pathway. A first ink delivery pathway 122 is in fluid communication with the first nozzle array 120, and a second ink delivery pathway 132 is in fluid communication with the second nozzle array 130. Portions of ink delivery pathways 122 and 132 are shown in FIG. 1 as openings through substrate 111. One or more inkjet printhead die 110 will be included in inkjet printhead 100, but for greater clarity only one inkjet printhead die 110 is shown in FIG. 1. The printhead die are arranged on a support member as discussed below relative to FIG. 2. In FIG. 1, first fluid source 18 supplies ink to the first nozzle array 120 via the first ink delivery pathway 122, and second fluid source 19 supplies ink to the second nozzle array 130 via the second ink delivery pathway 132. Although distinct fluid sources 18 and 19 are shown, in some applications it can be beneficial to have a single fluid source supplying ink to both the first nozzle array 120 and the second nozzle array 130 via ink delivery pathways 122 and 132, respectively. Also, in some embodiments, fewer than two or more than two nozzle arrays can be included on printhead die 110. In some embodiments, all nozzles on inkjet printhead die 110 can be the same size, rather than having multiple sized nozzles on inkjet printhead die 110.

Not shown in FIG. 1, are the drop forming mechanisms associated with the nozzles. Drop forming mechanisms can be of a variety of types, some of which include a bubble nucleating heating element to vaporize a portion of ink and thereby cause ejection of an ink droplet, or a piezoelectric transducer to constrict the volume of a fluid chamber and thereby cause ejection of an ink droplet, or an actuator which is made to move (for example, by heating a bi-layer element) and thereby cause ejection of an ink droplet. In any case, electrical pulses from electrical pulse source 16 are sent to the various drop ejectors according to the desired deposition pattern. In the example of FIG. 1, ink droplets 181 ejected from the first nozzle array 120 are larger than ink droplets 182 ejected from the second nozzle array 130, due to the larger nozzle opening area. Typically other aspects of the drop forming mechanisms (not shown) associated respectively with nozzle arrays 120 and 130 are also sized differently in order to optimize the drop ejection process for the different sized drops. During operation, droplets of ink are deposited on the recording medium 20. A nozzle plus its associated drop forming mechanism are included in a drop ejector. Sometimes herein the terms drop ejector array and nozzle array are used interchangeably.

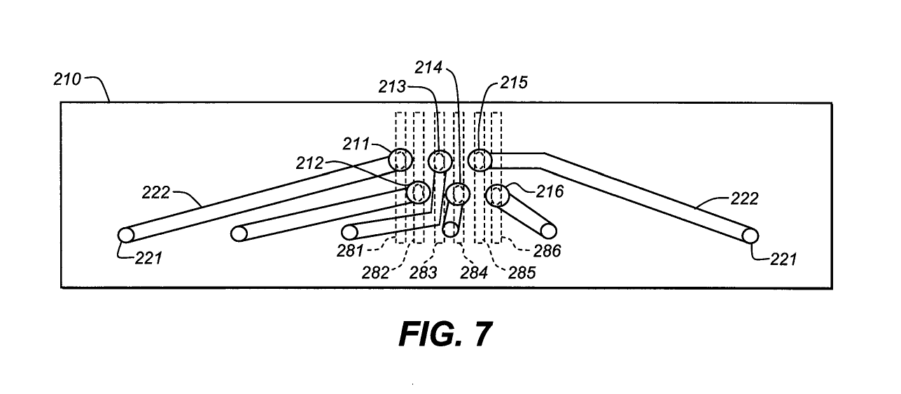

FIG. 2 shows a perspective of a portion of a printhead 250, which is an example of an inkjet printhead 100 as shown in FIG. 1. Printhead 250 includes three printhead die 251 (similar to printhead die 110 in FIG. 1), each printhead die 251 containing two nozzle arrays 253, so that printhead 250 contains six nozzle arrays 253 altogether. The three printhead die 251 are bonded to a mounting member 255, which provides a planar mounting surface for the printhead die 251, as well as ink passageways (not shown) that provide ink to respective ink openings in the substrates of printhead die 251. Manifold 210 (described below with reference to FIG. 7) provides ink passages that lead to the corresponding ink passageways of mounting member 255. The six nozzle arrays 253 in this example can be each connected to separate ink sources (not shown), such as cyan, magenta, yellow, text black, photo black and a colorless fluid. (Other configurations of printheads described below only include four nozzle arrays. The number of nozzle arrays in the printhead is not central to the invention.)

Each of the six nozzle arrays 253 is disposed along nozzle array direction 254, and the length of each nozzle array along the nozzle array direction 254 is typically on the order of 1 inch or less. Typical lengths of recording media are 6 inches for photographic prints (4 inches by 6 inches), or 11 inches for cut sheet paper (8.5 by 11 inches) in a desktop carriage printer, or several feet for roll-fed paper in a wide format printer. Thus, in order to print a full image, a number of swaths are successively printed while moving printhead 250 across the recording medium 20. Following the printing of a swath, the recording medium 20 is advanced in a direction that is substantially parallel to nozzle array direction 254.

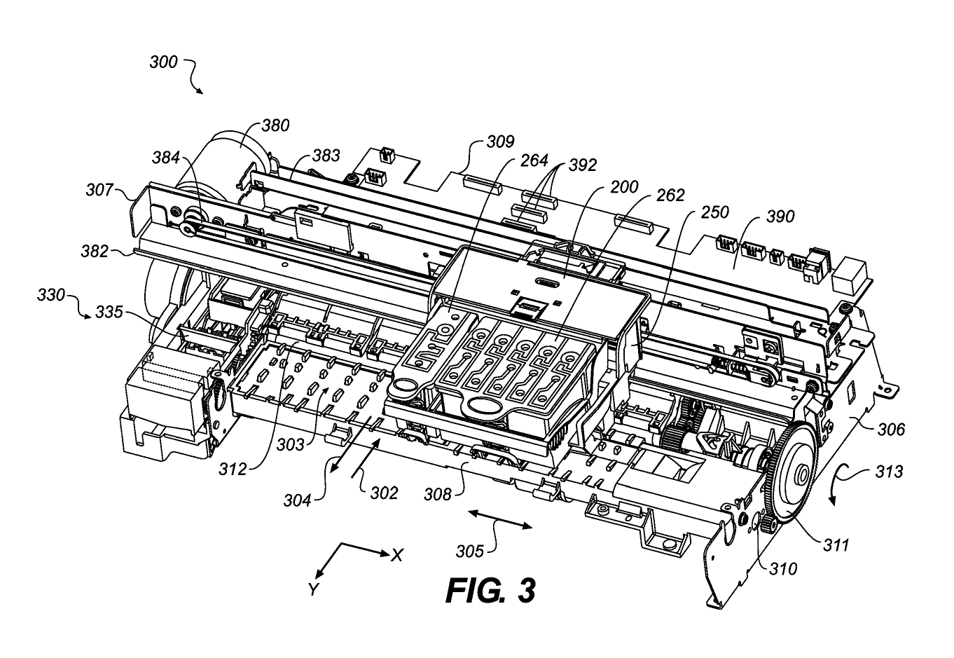

Also shown in FIG. 2 is a flex circuit 257 to which the printhead die 251 are electrically interconnected, for example, by wire bonding or TAB bonding. The interconnections are covered by an encapsulant 256 to protect them. Flex circuit 257 bends around the side of printhead 250 and connects to connector board 258. When printhead 250 is mounted into the carriage 200 (see FIG. 3), connector board 258 is electrically connected to a connector (not shown) on the carriage 200, so that electrical signals can be transmitted to the printhead die 251.

FIG. 3 shows a top perspective of a printer chassis 300 for a desktop carriage printer. Some of the parts of the printer have been hidden in the view shown in FIG. 3 so that other parts can be more clearly seen. The printer chassis has a print region 303 across which carriage 200 is moved back and forth (also sometimes called rightward and leftward passes herein) along carriage scan axis 305 (parallel to the X axis), between the right side of printer chassis 306 and the left side of printer chassis 307, while drops are ejected from printhead die 251 (not shown in FIG. 3) on printhead 250 that is mounted on carriage 200. Carriage motor 380 moves belt 384 to move carriage 200 laterally along carriage guide rail 382 in reciprocating fashion. An encoder sensor (not shown) is mounted on carriage 200 and indicates carriage location relative to an encoder fence 383.

Printhead 250 is mounted in carriage 200, and multi-chamber ink supply 262 and single-chamber ink supply 264 are mounted in the printhead 250. The mounting orientation of printhead 250 is rotated relative to the view in FIG. 2, so that the printhead die 251 are located at the bottom side of printhead 250, the droplets of ink being ejected downward onto the recording medium in print region 303 in the view of FIG. 3. Paper or other recording medium (sometimes generically referred to as paper or media herein) is loaded along paper load entry direction 302 toward the front of printer chassis 308.

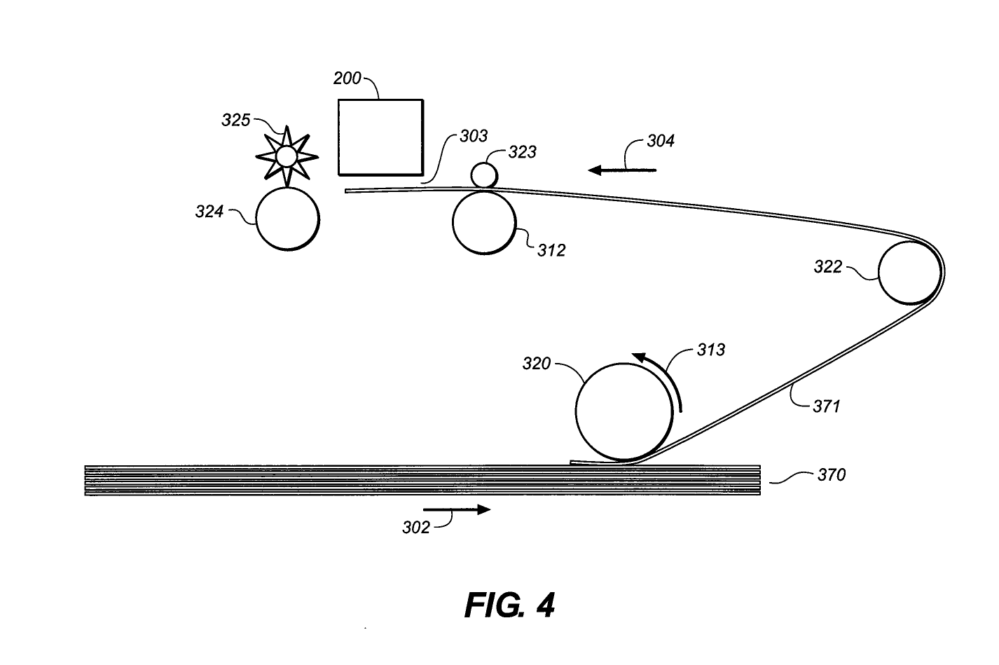

A variety of rollers are used to advance the medium through the printer as shown schematically in the side view of FIG. 4. In this example, a pick-up roller 320 moves the top piece or sheet 371 of a stack 370 of paper or other recording medium in the paper load entry direction 302. A turn roller 322 acts to move the paper around a C-shaped path (in cooperation with a curved rear wall surface) so that the paper continues to advance along media advance direction 304 from the rear of the printer chassis 309 (with reference to FIG. 3). The paper is then moved by feed roller 312 and idler roller 323 to advance along the Y axis across print region 303, and from there to a discharge roller 324 and star wheel(s) 325 so that printed paper exits along media advance direction 304. Feed roller 312 includes a feed roller shaft along its axis, and feed roller gear 311 (see FIG. 3) is mounted on the feed roller shaft. Feed roller 312 can include a separate roller mounted on the feed roller shaft, or can include a thin high friction coating on the feed roller shaft. A rotary encoder (not shown) can be coaxially mounted on the feed roller shaft in order to monitor the angular rotation of the feed roller.

The motor that powers the paper advance rollers is not shown in FIG. 3, but a hole 310 on the right side of the printer chassis 306 is where the motor gear (not shown) protrudes through in order to engage feed roller gear 311, as well as the gear for the discharge roller (not shown). For normal paper pick-up and feeding, it is desired that all rollers rotate in forward rotation direction 313. Toward the left side of the printer chassis 307, in the example of FIG. 3, is the maintenance station 330.

Toward the rear of the printer chassis 309, in this example, is located the electronics board 390, which includes cable connectors 392 for communicating via cables (not shown) to the printhead carriage 200 and from there to the printhead 250. Also on the electronics board are typically mounted motor controllers for the carriage motor 380 and for the paper advance motor, a processor or other control electronics (shown schematically as controller 14 and image processing unit 15 in FIG. 1) for controlling the printing process, and a connector for a cable to a host computer.

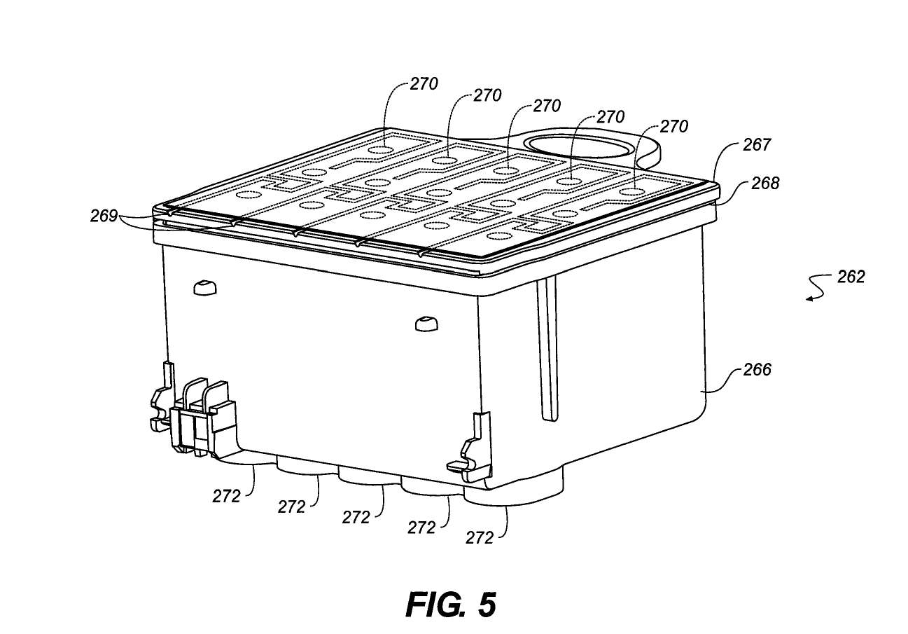

FIG. 5 shows a perspective view of multi-chamber ink supply 262 removed from printhead 250. Multi-chamber ink supply 262 includes a supply body 266 and a lid 267 that is sealed (e.g. by welding) to ink supply body 266 at lid sealing interface 268. Lid 267 individually seals all of the chambers 270 in the ink supply. In the example shown in FIG. 5, multi-chamber ink supply 262 has five chambers 270 below lid 267, and each chamber has a corresponding ink supply port 272 that is used to transfer ink to the printhead die 251. As shown in FIG. 3, the ink supplies 262 and 264 are mounted on the carriage 200 printer chassis 300, such that the lid 267 is at an upper surface, and correspondingly ink supply ports 272 are at a lower surface. Corresponding to each chamber position, there is a circuitous air path in lid 267 (shown as dotted lines) that exits the side of lid 267 at vents 269 (only two of which are labeled in FIG. 5 for improved clarity). Vents 269 help to relieve pressure differences in chamber 270 as ink is depleted during usage.

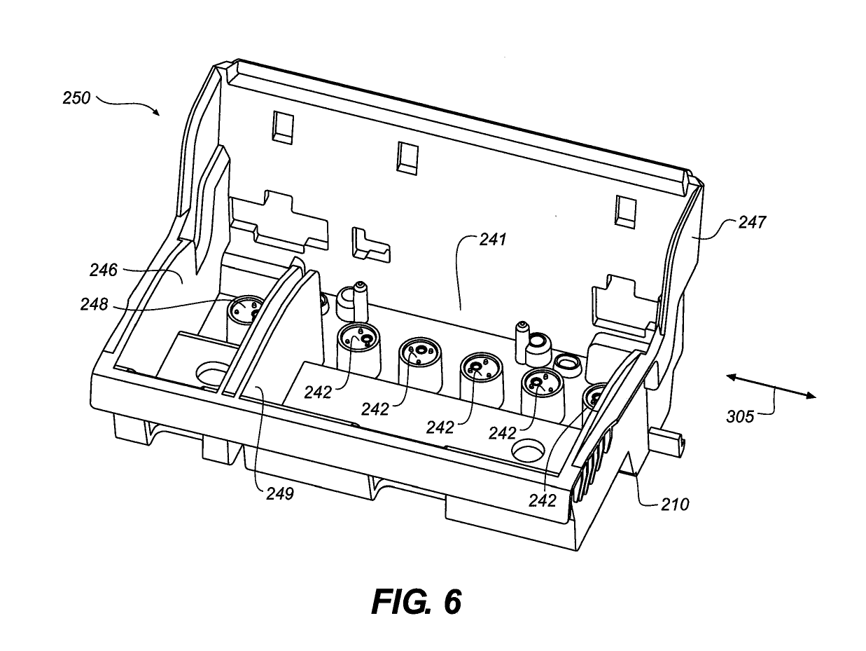

FIG. 6 shows a top perspective view of the printhead 250 without either replaceable ink supply 262 or 264 mounted in it. Multi-chamber ink supply 262 is mountable in a multi-chamber ink supply region 241 and single-chamber ink supply 264 is mountable in a single-chamber ink supply region 246 of printhead 250. Multi-chamber ink supply region 241 is separated from single-chamber ink supply region 246 by partitioning wall 249, which can also help guide the ink supplies during insertion. Five multi-chamber ink supply connection ports 242 are shown in multi-chamber ink supply region 241 that connect with ink supply ports 272 of multi-chamber ink supply 262 when it is installed, and one single-chamber ink supply connection port 248 is shown in single-chamber ink supply region 246 for the ink supply port on the single-chamber ink supply 264. When an ink supply is installed in the printhead 250, it is in fluid communication with the printhead because of the connection of ink supply port 272 with connection ports 242 or 248. When the printhead 250 is installed in carriage 200 of the printer (with reference to FIG. 3), connection ports 242 and 248 are displaced with respect to each other along the carriage scan axis 305.

In order to provide sufficient capacity for storing ink, the ink chambers 270 are typically wider than the spacing between drop ejector arrays 253 (with reference to FIG. 2), so that connection ports 242 and 248 are not directly in line with ink passageways in mounting member 255. In other words, the connection ports 242 and 248 are more widely spaced along carriage scan axis 305 than the drop ejector arrays 253.

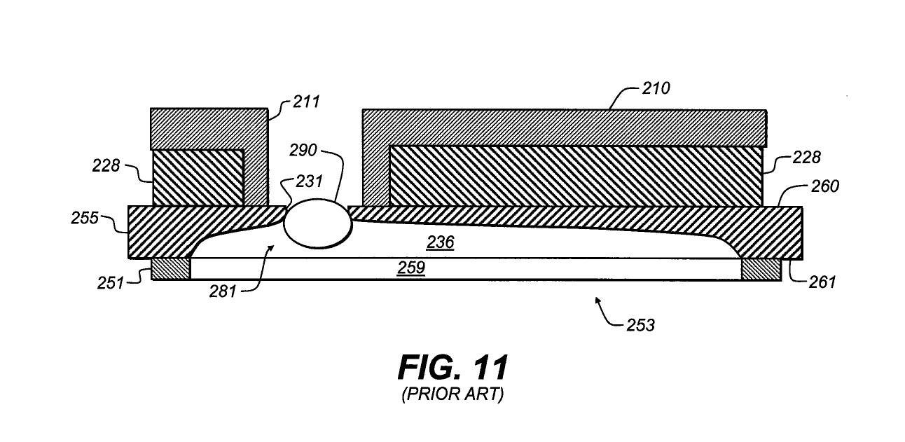

FIG. 7 shows a bottom view (opposite sense from FIGS. 3 and 6) of a prior art manifold 210 that provides passageways from connection ports 242 and 248 to the ink passageways 281-286 (shown as dotted rectangles to indicate their position relative to the manifold 210) in mounting member 255 in order to provide ink to respective ink openings in the substrates of printhead die 251. Manifold 210 includes six manifold ink supply openings 211-216 that provide ink respectively to the ink passageways 281-286 in mounting substrate 255. As shown with reference to the cross-sectional view of FIG. 11, manifold ink supply openings 211-216 are typically tube-shaped and are fluidically connected to openings in the mounting member as described below. Ink enters manifold 210 at manifold entry ports 221, which are aligned with the connection ports 242 and 248 at a face opposite the face where the ink supply ports 272 contact the manifold entry ports 221. In a particular example, the distance between endmost ink passageways 281 and 286 is about 1 cm, and the distance between endmost manifold entry ports 221 is about 7 cm. Manifold passages 222 are provided to bring ink from a manifold entry port 221 to the corresponding manifold ink supply opening.

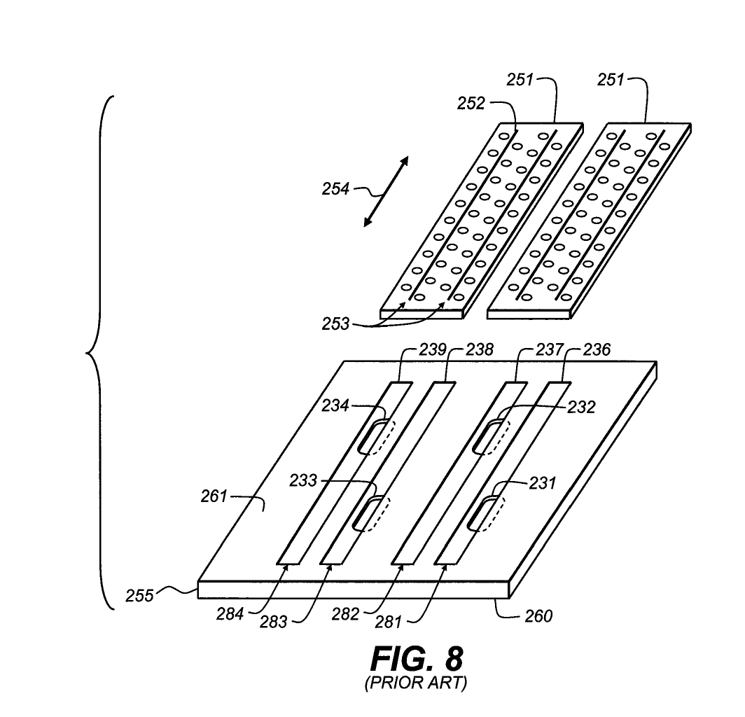

Referring to FIG. 8, the mounting member 255 and the printhead die 251 are shown detached from each other and in an orientation opposite their orientation during normal printing for more clearly illustrating their cooperative interaction. It is noted that two printhead die 251 are shown although more than two may be used or alternatively only one printhead die 251 may be used depending on design choice. Since in this example each printhead die 251 includes two nozzle arrays 253, there are four nozzle arrays total, so that the mounting substrate 255 includes four ink passageways 281-284. The plurality of ink passageways 281-284 respectively include elongated openings 236-239 that are disposed on die attach surface 261 and each passageway respectively includes an opening 231-234 that is disposed on ink entry surface 260 (the openings are shown in dashed lines indicating their physical location is on the opposite surface from die attach surface 261). Ink is transported from the ink manifold supply openings 211-214 (see FIG. 7) and respectively into the openings 231-234 where each opening disperses the received ink into its respective ink passageway 281-284. The printhead die 251 includes a plurality of ink feeds 252 that are respectively mated to the ink passageways 281-284. It is noted that the nozzle array 253 is aligned along a nozzle array direction 254, and the ink passageways 281-284 and ink feeds 252 are also aligned along the nozzle array direction 254.

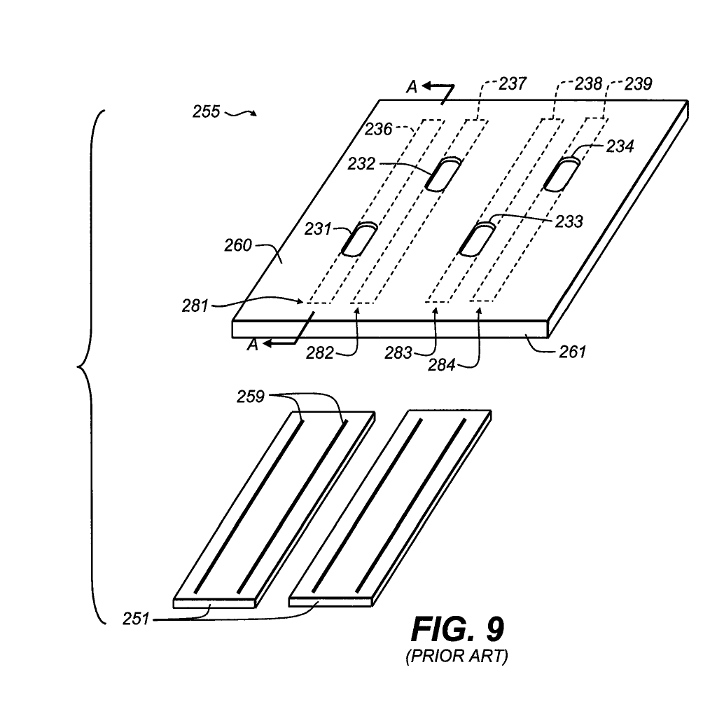

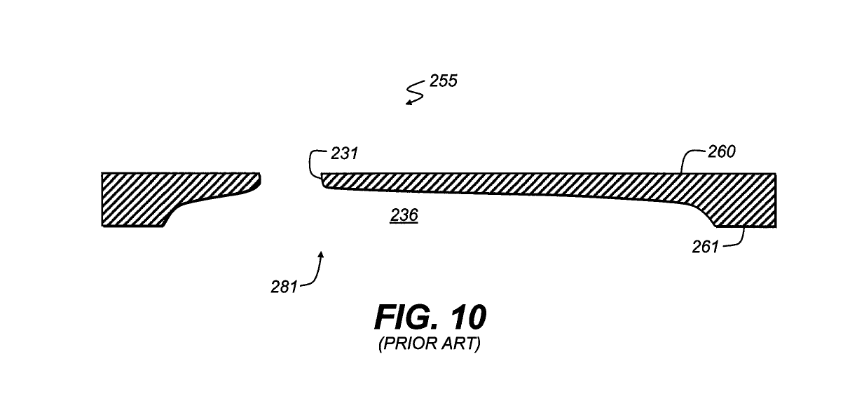

Referring to FIG. 9, the mounting member 255 and the printhead die 251 are shown in their normal orientation during printing and are again shown as being detached for illustration clarity. It is noted that a cross-sectional line A-A passes through the center of one of the ink passageways 281 whose cross-sectional view is shown in FIG. 10. In this figure, the mounting substrate 255 includes the ink passageway 281 which includes an opening 231 on ink entry surface 260 that leads to an elongated opening 236 on die attach surface 261. Also shown in FIG. 9 is a plurality of ink feed openings 259 on printhead die 251. Ink feed openings 259 are fluidically connected to corresponding ink feeds 252 and nozzle arrays 253 seen in FIG. 8.

Referring to FIG. 11, the mounting substrate 255 is shown having the manifold 210 fluidically connected to it. The manifold 210 includes a manifold ink supply opening 211 through which ink passes as it flows through opening 231 to the elongated opening 236. A gasket 228 surrounds each manifold ink supply opening 211 for preventing ink from leaking as it passes to the opening 231. As ink passes from the ink manifold supply opening 211 through opening 231 to the elongated opening 236, an air bubble 290 may form in the opening 231 which obstructs the flow of ink. Buoyancy tends to push bubble 290 upward toward manifold ink supply opening 211, but the pressure needed to force the bubble 290 through opening 231 into the manifold ink supply opening 211 is not available because the nozzles in nozzle array 253 are effectively sealed by ink. Consequently the air bubble 290 becomes lodged in the opening 231 which obstructs or even prevents ink flow. This is obviously undesirable for reliable jetting of ink and the present invention overcomes this problem as discussed hereinbelow.

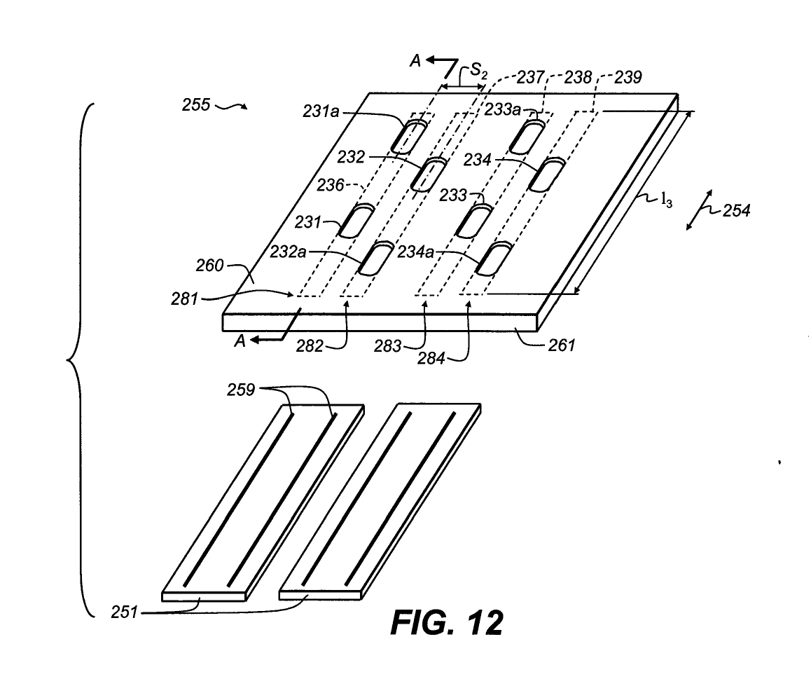

Referring to FIG. 12, there is shown the mounting member 255 and printhead die 251 of the present invention. It is noted that all components having the same number as in FIGS. 1-11 are the same as discussed for the prior art. However, in the mounting member 255 of the present invention, there is a plurality of openings, preferably two openings although more than two openings may also be used, in each ink passageway 281-284. More specifically, ink passageway 281 includes openings 231 and 231a; ink passageway 282 includes openings 232 and 232a; ink passageway 283 includes openings 233 and 233a; and ink passageway 284 includes openings 234 and 234a. This enables each ink passageway 281-284 to have sufficient pressure to dislodge any air bubbles that may form. In other words, this reduces the required pressure difference across any single opening to dislodge any air bubbles that may form. It is noted in this example that adjacent elongated openings 236-239 are displaced from each other along a direction substantially perpendicular to the nozzle array direction 254 by a distance (S₂) that is less than one quarter of the length dimension (I₃) of any elongated opening 236. This is because it is desirable to closely space the nozzle arrays 253 on printhead die 251 so that the printhead die size and die cost can be reduced. However, it is also desirable to configure nozzle arrays 253 with a sufficient length along the nozzle array direction 254 to provide a printing swath length that is compatible with fewer printing passes and therefore higher speed printing.

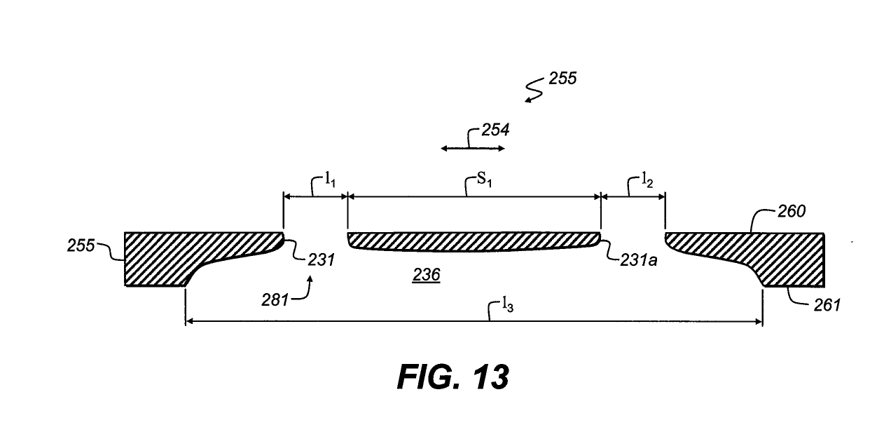

Referring to FIG. 13, there is shown one of the ink passageways of the present invention, ink passageway 281, illustrating in more detail the two openings 231 and 231a in ink passageway 281 which openings are fluidically connected together. It is noted that the opening 231 includes a first length (I₁) along the nozzle array direction 254, and the opening 231a also includes a second length (I₂) along the nozzle array direction 254. This is noted because the elongated opening 236 includes a third length (I₃) along the nozzle array direction 254 in which the first length (I₁) and the second length (I₂) are each preferably less than one third of the third length (I₃). It is further noted that the opening 231 is separated from the opening 231a along the nozzle array direction 254 by a distance (S1) that is greater than the length (I₁) or (I₂). Preferred lengths and spacings for I₁ and I₂ can depend on the ink flow throughput required for printing at high frequency, as well as on the details of sealing the openings 231 and 231a to corresponding ink supply openings in the manifold.

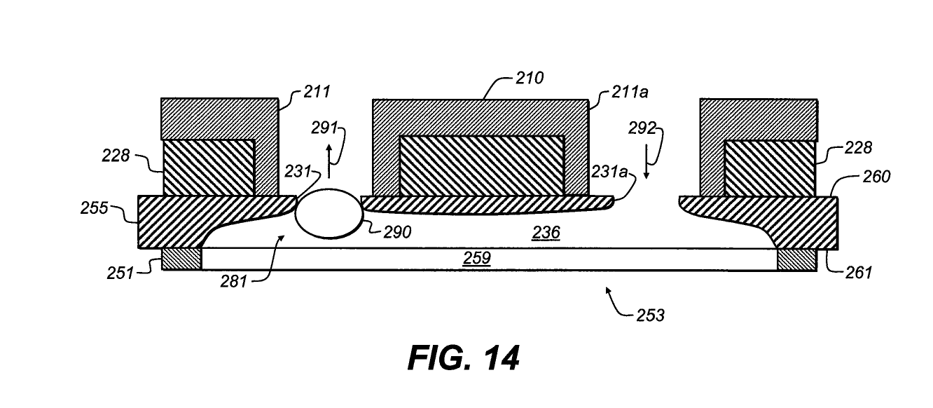

Referring to FIG. 14, there is shown the manifold 210 fluidically connected to mounting member 255 and printhead die 251 attached to the mounting member 255. It is noted that the size of the ink supply openings of the ink manifold is greater than the size of the corresponding openings of the ink passageways. For example, the size of ink supply openings 211 and 211a is greater that the size of the corresponding openings 231 and 231a of the ink passageway 281. Again, all components having the same number as in FIGS. 1-11 are the same as discussed for the prior art. If an air bubble 290 forms, the ink which is flowing in the ink direction 292 reduces the pressure difference required for the air bubble 290 to move upwardly and out of the opening 231 as illustrated by arrow 291. Even prior to dislodging of the air bubble 290, opening 231 provides an additional ink flow path to the printhead die 251 so that reliable jetting of ink is facilitated.

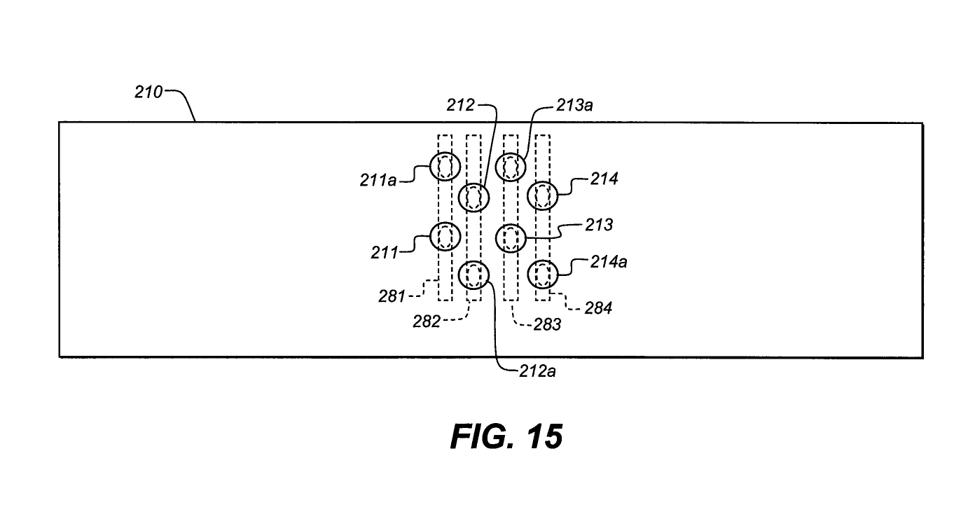

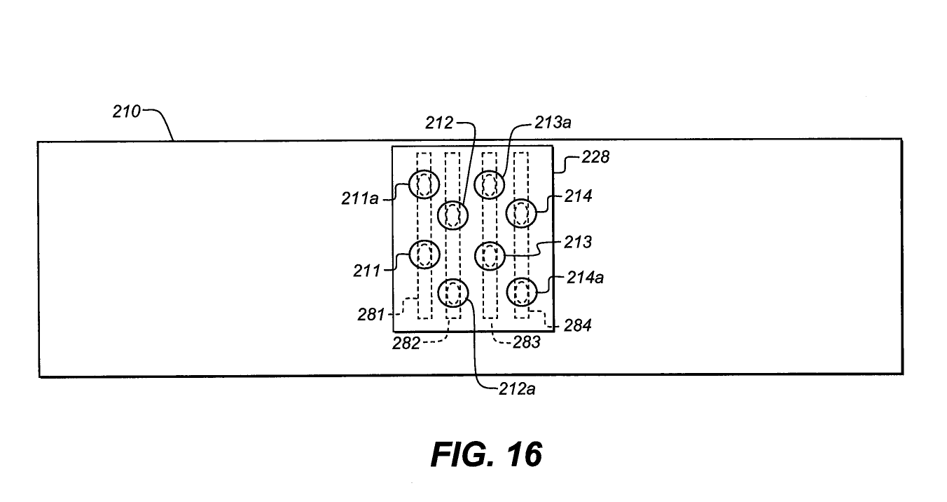

Referring to FIG. 15, there is shown the manifold 210 having the plurality of manifold supply openings 211-214 and 211a-214a. It is noted that two manifold supply openings are mated with each ink passageway 281-284 for providing sufficient ink flow through each opening in the ink passageway 281-284 so that sufficient pressure is provided for dislodging any air bubbles. It is noted that ink supply openings for a particular ink passageway 281-284 are staggered relative to ink supply openings for an adjacent ink passageway 281-284. For example, ink supply openings 211 and 211a are staggered relative to ink supply openings 212 and 212a. FIG. 16 illustrates the manifold 210 having the gasket 228 which is configured to match the physical configuration of the manifold supply openings 211-214 and 211a-214a for sealing each manifold supply opening 211-214 and 211a-214a respectively with the openings 231-234 and 231a-234a for preventing ink leakage. Preferably the gasket 228 is a single-piece gasket (as illustrated) although a plurality of individual circular gaskets may be used in which one gasket is mated with each supply opening.

The invention has been described in detail with particular reference to certain preferred embodiments thereof, but it will be understood that variations and modifications can be effected within the spirit and scope of the invention.

### PARTS LIST

12 Image data source
14 Controller
15 Image processing unit
16 Electrical pulse source
18 First fluid source
19 Second fluid source
20 Recording medium
100 Inkjet printhead
110 Inkjet printhead die
111 Substrate
120 First nozzle array
121 Nozzles
122 First ink delivery pathway
130 Second nozzle array
131 Nozzles
132 Second ink delivery pathway
181 Ink droplets
182 Ink droplets
200 Carriage
210 Manifold
211 Manifold ink supply opening
211a Manifold ink supply opening
212 Manifold ink supply opening
212a Manifold ink supply opening
213 Manifold ink supply opening
213a Manifold ink supply opening
214 Manifold ink supply opening
214a Manifold ink supply opening
215 Manifold ink supply opening
216 Manifold ink supply opening
221 Manifold entry port
222 Manifold passage
228 Gasket
231 Opening (in mounting member ink passageway)
231a Opening (in mounting member ink passageway)
232 Opening (in mounting member ink passageway)
232a Opening (in mounting member ink passageway)
233 Opening (in mounting member ink passageway)
233a Opening (in mounting member ink passageway)
234 Opening (in mounting member ink passageway)
234a Opening (in mounting member ink passageway)
236 Elongated opening (ink mounting member ink passageway)
237 Elongated opening (ink mounting member ink passageway)
238 Elongated opening (ink mounting member ink passageway)
239 Elongated opening (ink mounting member ink passageway)
241 Multi-chamber ink supply region
242 Multi-chamber ink supply connection port
246 Single-chamber ink supply region
248 Single-chamber ink supply connection port
249 Partitioning wall
250 Printhead
251 Printhead die
252 Ink feed
253 Nozzle arrays
254 Nozzle array direction
255 Mounting member
256 Encapsulant
257 Flex circuit
258 Connector board
259 Ink feed opening
260 Ink entry surface (of mounting member)
261 Die attach surface (of mounting member)
262 Multi-chamber ink supply
264 Single-chamber ink supply
266 Ink supply body
267 Lid
268 Lid sealing interface
269 Vents
270 Ink chamber
272 Ink supply ports
281 Ink passageway
282 Ink passageway
283 Ink passageway
284 Ink passageway
285 Ink passageway
286 Ink passageway
290 Bubble
291 Bubble flow direction
292 Ink flow direction
300 Printer chassis
302 Paper load entry direction
303 Print region
304 Media advance direction
305 Carriage scan axis
306 Right side of printer chassis
307 Left side of printer chassis
308 Front of printer chassis
309 Rear of printer chassis
310 Hole (for paper advance motor drive gear)
311 Feed roller gear
312 Feed roller
313 Forward rotation direction
320 Pick-up roller
322 Turn roller
323 Idler roller
324 Discharge roller
325 Star wheel(s)
330 Maintenance station
370 Stack of media
371 Top piece of medium
380 Carriage motor
382 Carriage guide rail
383 Encoder fence
384 Belt
390 Printer electronics board
392 Cable connectors

1. An inkjet printhead comprising:
a printhead die including an array of nozzles disposed along a nozzle array direction and an ink feed opening that is fluidically connected to the array of nozzles; and
a mounting member including:
a first surface to which the printhead die is affixed;
a second surface opposite the first surface; and
an ink passageway from the second surface to the first surface, the ink passageway including:
an elongated opening disposed on the first surface, the elongated opening being adjacent the ink feed opening of the printhead die; and
a first opening and a second opening disposed on the second surface, the first and second openings being fluidically connected to the elongated opening disposed on the first surface.

2. The inkjet printhead of claim 1, the first opening including a first length along the nozzle array direction, the second opening including a second length along the nozzle array direction, and the elongated opening including a third length along the nozzle array direction, wherein the first length and the second length are each less than one third of the third length.

3. The inkjet printhead of claim 2, wherein the first opening is separated from the second opening along the nozzle array direction by a distance that is greater than the first length.

4. The inkjet printhead of claim 1, the array of nozzles being a first array of nozzles, the ink feed opening being a first ink feed opening, the ink passageway being a first ink passageway, and the elongated opening being a first elongated opening, the inkjet printhead further comprising:
a second array of nozzles disposed along the nozzle array direction;
a second ink feed opening that is fluidically connected to the second array of nozzles; and
a second ink passageway from the second surface of the mounting member to the first surface of the mounting member, the second ink passageway including:
a second elongated opening disposed on the first surface of the mounting member, the second elongated opening being adjacent the second ink feed opening; and
a third opening and a fourth opening disposed on the second surface of the mounting member, the third and fourth openings being fluidically connected to the second elongated opening on the first surface.

5. The inkjet printhead of claim 4, wherein the printhead die includes the second array of nozzles.

6. The inkjet printhead of claim 4, the printhead die being a first printhead die, the inkjet printhead further comprising a second printhead die including the second array of nozzles and the second ink feed opening.

7. The inkjet printhead of claim 4, the first elongated opening including a length dimension, wherein the second elongated opening is displaced from the first elongated opening along a direction substantially perpendicular to the nozzle array direction by a distance that is less than one quarter of the length dimension of the first elongated opening.

8. The inkjet printhead of claim 4, wherein the first and second openings of the first ink passageway are staggered relative to the third and fourth openings of the second ink passageway.

9. The inkjet printhead of claim 4 further comprising an ink manifold including:
a first ink supply opening disposed adjacent the first opening of the first ink passageway;
a second ink supply opening disposed adjacent the second opening of the first ink passageway;
a third ink supply opening disposed adjacent the third opening of the second ink passageway; and
a fourth ink supply opening disposed adjacent the fourth opening of the second ink passageway.

10. The inkjet printhead of claim 9 further comprising a single-piece gasket to seal between the ink supply openings of the ink manifold and the corresponding openings of the first and second ink passageways.

11. The inkjet printhead of claim 9, wherein the first and second ink supply openings of the ink manifold are staggered relative to the third and fourth ink supply openings of the ink manifold.

12. The inkjet printhead of claim 9, wherein a size of the ink supply openings of the ink manifold is greater than a size of the corresponding openings of the first and second ink passageways.

13. The inkjet printhead of claim 1, the ink passageway further comprising more than two openings disposed on the second surface that are fluidically connected to the elongated opening disposed on the first surface of the mounting member.

14. The inkjet printhead of claim 1 further comprising an array of bubble-nucleating heating elements.

15. The inkjet printhead of claim 1 further comprising an array of piezoelectric transducers.

16. An inkjet printer comprising:
a media advance system for advancing print media along a media advance direction;
an inkjet printhead comprising:
a printhead die including an array of nozzles disposed along a nozzle array direction and an ink feed opening that is fluidically connected to the array of nozzles; and
a mounting member including:
a first surface to which the printhead die is affixed;
a second surface opposite the first surface; and
an ink passageway from the second surface to the first surface, the ink passageway including:
an elongated opening disposed on the first surface, the elongated opening being adjacent the ink feed opening of the printhead die; and
a first opening and a second opening disposed on the second surface, the first and second openings being fluidically connected to the elongated opening disposed on the first surface.

17. The inkjet printer of claim 16 further comprising a carriage for conveying the inkjet printhead along a print zone in a direction that is substantially perpendicular to the media advance direction.
